(19) United States
(12) Patent Application Publication
(10) Pub. No.: US 2009/0119303 A1
(43) Pub. Date: May 7, 2009

(54) DEVICE FOR MANAGING MEDIA SERVER RESOURCES FOR INTERFACING BETWEEN APPLICATION SERVERS AND MEDIA SERVERS IN A COMMUNICATION NETWORK

(75) Inventors: David Rio, Bruz (FR); Guylaine Queau, Verrieres-Le-Buisson (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL LUCENT, Paris (FR)

(21) Appl. No.: 11/996,381

(22) PCT Filed: Jul. 17, 2006
(86) PCT No.: PCT/FR2006/050722

§ 371 Date: Mar. 6, 2008

(30) Foreign Application Priority Data
Jul. 22, 2005 (FR) 0552273

(51) Int. Cl. G06F 15/16; G06F 17/30

(52) U.S. Cl. 707/10; 709/203; 707/E17.032

(57) ABSTRACT

The invention concerns a device (D) dedicated to managing media server resources (MSj) in a communication network (CR), adapted to provide sets of media functions for providing the media parts of the requested services to client communication terminals (T) requesting services, comprising at least one media part, managed by application servers (ASi). Said device (D) comprises storage means (BD) storing data representative of media functions matching the media server identifiers (MSj) and managing means (MG) adapted, upon receiving a message from an application server (ASi) dedicated to a service requested by a client terminal (T) and requiring the provision of a set of media functions for providing a media part of the requested service, to determine the identifier of a media server (MSj) having the resources for offering the requested set, in the storage means (BD), then allocate resources of said media server (MSj) so that the message may be transmitted thereto.

### DISCLOSURE

The invention relates to communication networks with an IP type network core (in other words end to end IP networks in which the user has an IP (Internet Protocol) link, and networks have an IP type network core accessed by another technology through a gateway), for example IMS (IP Multimedia System) or NGN (New (or Next) Generation Network) type networks, and more particularly access of communication terminals to services comprising at least a media part and provided to their users through such networks.

As a person skilled in the art will be aware, when a communication terminal needs to access a service comprising at least one media part, it must transmit an access request to said service at the initiative of its user or the network core, to the network of which it is a client. For example, when the message complies with the SIP (Session Initiation Protocol) communication setup protocol, used to create and manage data exchange sessions between equipment (all forms of data), particularly interactive and in real time, independently of the nature of the data and the transport protocol used to transport said data, it is in the form of an SIP call setup message of the “SIP INVITE” type. Remember that an INVITE message contains an “SDP” describing the different media supported by a calling terminal, and that after this INVITE message is received, a negotiation is performed between equipment to determine which media will be used during the session.

When the network receives the request, it routes it to the application server (or one of the application servers) (or application servers dedicated (at least) to this service, in other words with the specific task of managing and testing supply of the requested service to the requesting terminal. Each service comprising at least one media part must use at least a set of media functions performed by the media server(s) to perform this media part. Such a set is also called a capability. Each media server has a number of resources (or channels) to perform its capability(ies).

When an application server receives a request to access a service comprising at least one media part, it must contact at least one media server capable of performing the media functions for the set corresponding to this media part (immediately or during the session). This might be impossible in some circumstances. Existing application servers cannot natively interface media servers that were not designed by their own manufacturer, and therefore they are incapable of natively using an arbitrary capacity supplied by an arbitrary media server.

For an application server to be able to interface a particular media server (made by another manufacturer), special arrangements (or adaptations) to it are necessary in order to use its capacities and control the media processing that it does. In other words, either all application servers and all media servers must be located on the same platform, or each manufacturer must design his own adaptation interfaces which must be updated every time that a new media server appears and must be used with its application servers.

Moreover, the media part of an application server, initially designed for IN (Intelligent Network) type networks has to be completely rewritten if it is to be ported onto NGM or IMS type networks.

Furthermore, there is no mechanism for making the availability state of media server resources transparent for application servers. Consequently, it is impossible to assign resource usage priorities as a function of the application type concerned and/or the requested call type and/or a contractual distribution of the resources (or multi-tenancy) if any, of some media servers between clients.

Therefore, the purpose of the invention is to correct all or some of the above-mentioned disadvantages.

To achieve this, it discloses a device dedicated to management of media server resources, in a communication network, designed to offer sets of media functions (or capacities) capable of performing the media parts of said required services to client communication terminals requiring services (comprising at least one media part) managed by application servers.

This management device is characterized by the fact that it comprises:
storage means required to store data representing sets of media functions corresponding to media server identifiers, and
management means that, when they receive a message from an application server dedicated to a service required by a client terminal and requiring this client terminal to be provided with a set of media functions capable of performing a media part of the required service, determine the identifier of a media server with the resources to offer the required set among the data stored on the storage means (using an appropriate strategy, on which the network operator can take action), and then allocate resources of the determined media server so that the message can be transmitted to it.

The device according to the invention may comprise other characteristics that may be taken separately or in combination, and particularly:
its storage means may be arranged to store auxiliary data representative of availability states of media server resources and/or the sizing of media servers as a function of data representative of sets of media functions and identifiers of media servers;
its management means may be made to allocate media server resources as a function of auxiliary data and/or management information (for example related to priorities and/or an operating strategy and/or geographic constraints and/or geographic distributions of media servers and/or a quality of service (QoS) and/or network architecture (channel size) and/or the quality or the state of the network at a given instant);
its storage means may also be arranged so as to be dynamically updated, for example by the management means when they receive information from media servers representative of sets offered by media servers and/or the corresponding available resources;
it may comprise firstly an input interface made to receive messages conforming with a first protocol from application servers, and transmitting these messages through management means, and secondly an output interface made to transmit messages communicated by the management means and that are addressed to them, to media servers.
   the output interface may for example be required to convert messages conforming with the first protocol into messages conforming with at least a second protocol before transmitting them to the destination media servers;
   for example, the first protocol is the SIP protocol, possibly encapsulating an AMSML (Alcatel (or Application) Media Server Markup Language) type protocol;
   the second protocol may for example be chosen from among the SIP protocol encapsulating an XML type protocol (MSML/MOML or MSCML) and an H248 type protocol;
it may be associated with a floating address, so as to enable useful redundancy in case of failure. In this case, the storage means may be shared by several management means and their access may be made secure.

The invention also discloses network equipment equipped with a management device of the type presented above. Such equipment may for example provide a particular allocation proxy function, particularly when the first protocol is SIP/AMSML. In other cases, it may form a state machine.

The invention is particularly well adapted, although not exclusively, to Internet, NGN or IMS type communication networks.

Other characteristics and advantages of the invention will appear after reading the description given in detail below and the appended drawings on which:

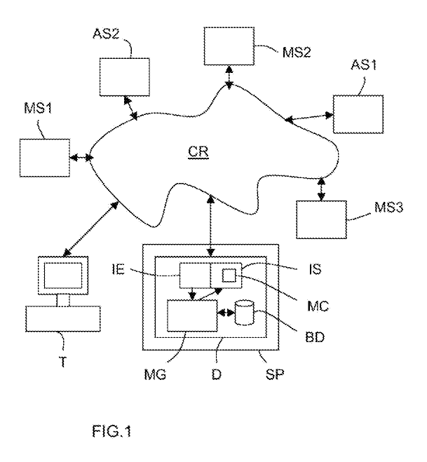

FIG. 1 very diagrammatically illustrates an IP network core to which application servers and media servers are connected, together with an example embodiment of a management device according to the invention, and

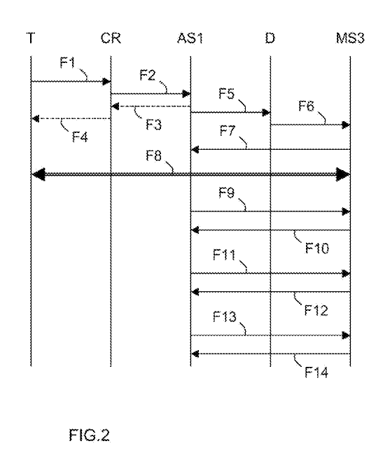

FIG. 2 is a diagram illustrating the main steps necessary to set up and control a media communication between a communication terminal and a media server according to the invention.

The appended drawings can be used not only to complete the invention, but also to contribute to its definition, if applicable.

The purpose of the invention is to enable standard interfacing using a resource management device, between the application control layer in application servers and the user plan layer in media servers, within a communication network comprising an IP (Internet Protocol) type network core. Another purpose is to hide the physical organization of media servers in the network from application servers (addresses, capacities and sizes).

In the following, we will consider that the communication network is an NGN or IMS type network, as a non-limitative example. But the invention is not limited to this type of network. It relates to any communication network comprising (or coupled to) an IP type network core, and particularly PSTN and PLMN type networks (provided that they include an IP network core).

We will refer firstly to FIG. 1 to describe a resource management device D according to the invention.

As shown very diagrammatically in FIG. 1, at least one application server ASi and at least one media server MSj may be coupled to a network core CR (in this case, of the NGN or IMS type). In the non-limitative example shown, firstly the index i is equal to 1 or 2, but it may be equal to any non-zero value, and secondly index j is equal to 1, 2 or 3 but it may be equal to any non-zero value.

It is important to note that FIG. 1 does not reflect the physical organization of the functional modules represented (application servers ASi, media servers MSj and device D). It would be possible for at least part of the media servers MSj and the device D to be physically located in the same equipment. It would also be possible to envisage that at least some of the application servers should be installed in the network core CR, for example in a software switch (softswitch).

Each application server ASi is dedicated to at least one service comprising at least one media part, for example such as a pre-payment service, or CMM (Corporate Mobility Manager—virtual office particularly useful for accessing personal information), messaging, conference, gateway, kiosk, downloading ring tones or “push to talk” type services. Consequently, it is made to manage and control the supply of a service for which it was designed to requesting communication terminals T.

For the purposes of this description, a “communication terminal” refers to any radio or wire, fixed or mobile (or portable) communication equipment that can be connected to at least one IP network, possibly through gateway(s) (particularly when the user is not aware that he is accessing on an IP network core), in order to exchange data in the form of signals with other equipment. For example, it may be a fixed or mobile telephone, or a fixed or portable computer or a Personal Digital Assistant (PDA) equipped with a communication module, possibly on IP.

For the purposes of this description, a “service comprising at least one media part” means any service at least partly related to a communication with the purpose of exchanging any form of media data flows, for example such as voice flows (VoIP for Voice over IP), video flows or text flows (for example of the “chat” type). It is important to note that flows may or may not be interactive in real time.

Each media server MSj is designed to provide at least one predefined set (or group) of media functions, also called the capacity, that can be used by application servers ASi to provide a media part of a service.

For the purposes of this description, a “media function” is any function related to a media communication, for example (and non-exhaustively) such as a basic audio or video announcement, an interactive audio or video session (DTMF collection), an ad-hoc audio or basic video conference, an extended audio or video conference, an audio voice XML scripting command string, a video VXML scripting command string, a voice synthesis (text to speech) or speech recognition.

According to the invention, each set (or capacity) is defined in a standard and univocal manner, and it is associated with a unique set identifier. In other words, there cannot be several different set identifiers associated with sets containing the same media functions. Consequently, if media servers are designed by different manufacturers and provide one or several sets of identical functions, these identical sets are associated with identical set identifiers.

Media servers MSj concerned by the invention form a sort of an equivalent common capacities base provided to application servers ASi.

Furthermore, each media server MSj is provided with a number of resources (or channels) to perform each of its capacities. A single network may contain media servers MSj supporting the same capacities, but with different sizes (different numbers of ports).

Furthermore, each media server MSj is preferably arranged to notify the network core CR each of its capacities and the availability state of resources associated with each of said capacities, and possibly usage priorities of at least some of the resources.

The resource management device D according to the invention is designed to provide the interface between application servers ASi and media servers MSj. To achieve this, it comprises at least storage means BD and at least one management module MG.

The storage means BD are required to store data representative of the different sets of media functions in the common base corresponding to identifiers of media servers MSj and availability states of their resources. For example, data representative of sets of media functions are set identifiers, and identifiers of media servers MSj are their IP addresses.

These storage means BD may be produced in any form, for example such as a memory or a database (as is the case below). It will be noted that the database may be persistent and/or redundant, depending on the information that it contains.

The management module MG is coupled to the database BD and is designed to determine the identifier of a media server MSj provided with resources to offer the required set, among the data stored by the database BD, every time that it receives a message from an application server ASi dedicated to a service comprising at least one media part and required by a client (communication) terminal T and requesting that this terminal should be provided with a set of media functions corresponding to the media part of the required service.

Then, once the management module MG has determined a media server MSj adapted to the received message, it allocates some of the resources of this media server MSj such that the received message can be transmitted to it and it proceeds to setup a communication with the requesting client terminal T in order to exchange the media flow (RTP type) by using the media functions of the set (or capacity) designated in said message.

It is important to note that with the invention, the management module MG may have auxiliary data (for example in the database BD), for example such as the availability state of resources of media servers MSj and/or their corresponding sizes, such that it can globally manage the resources available to it. In allocating resources, the management module MG can then take account of management information (possibly stored in the database DB), for example related to priorities (depending on the application type concerned and/or the requested call type and/or a possible contractual distribution of resources (or multi-tendency) of some media servers between clients) and/or an operating strategy and/or geographic constraints and/or geographic distributions of the media servers and/or a quality of service (QoS) and/or the network architecture (size of channels) and/or the quality or state of the network at a given instant.

Preferably, the database BD is updated dynamically. For example, the management module MG is required to update the database base BD every time that it receives data representative of its set(s) and/or auxiliary data (available resources and/or sizes) from a media server MSj (for example periodically), through the network core CR.

As shown in FIG. 1 as an example non-limitative embodiment, the device D may comprise an input interface IE and an output interface IS, both being coupled to its management module MG.

The input interface IE is required to receive messages conforming with a first protocol through the network core CR from application servers ASi, and transmitting these messages to the management module MG, to determine the media servers MSj that are capable of performing the designated media services in these messages. For example, the first protocol is the SIP (Session Initiation Protocol) protocol. As a variant, the first protocol could be the SIP protocol encapsulating an AMSML (“Alcatel (or Application) Media Server Markup Language) type protocol described in ALCATEL document 3AT 33 634 AAAA PLZZA-Ed 03 It7.

The output interface IS is at least made to transmit messages communicated by the management module MG and addressed to the media servers MSj determined by this management module MG, to the media servers MSj.

These messages may be either conforming with the first protocol and in this case the output interface IS only performs a distribution function, or they may be conforming with at least a second protocol and in this case the output interface IS performs a protocol conversion function and a distribution function. In the latter case and as illustrated, the output interface IS comprises a conversion module required to convert messages transmitted by the management module MG and conforming with the first protocol, into messages conforming with the second chosen protocol understandable by the media servers MSj.

For example, the second protocol is the SIP protocol encapsulating an XML (extended markup Language) type protocol, or an H248 type protocol.

The protocol encapsulated in the SIP protocol enables an application server ASi to dialogue with a media server MSj to manage and control the media communication that it needs to setup with a requesting terminal T, using dedicated media commands. Depending on the service type required by requesting terminal T, the dialogue may be either of the “session” type and in this case several dedicated media commands may be exchanged, or of the “non-session” type and in this case an initial dedicated media command and a final dedicated media command if any, may be exchanged.

Although it is not shown in FIG. 1, the network core CR may be coupled either to two resource management devices D according to the invention, or to a single resource management device D according to the invention, comprising at least two management modules MG and a common (or shared) database BD, to enable redundancy that is useful if a failure occurs in either of them or if there is a failure in the connection connecting the network core CR to either of them. In order to be able to quickly substitute one of the resource management devices D for another, or one of the management modules for another, they are preferably associated with a floating public IP address. This type of floating address enables the network core CR to quickly route messages from application servers ASi to the management device D, or the management module MG, which is in active/waiting mode or that may be reached. It is important to note that its access may be made secure if there is a common (or shared) database.

The management device D according to the invention, and particularly its management module(s) and its storage means BD, may be made in the form of electronic circuits, software (or computer) modules, or a combination of circuits and software.

As shown as a non-limitative example in FIG. 1, the device D according to the invention may for example be located in an SP IP network equipment in the form of a module performing a particular allocation “proxy” function. Note that in a 3GPP architecture, the device D may form an MRF-C type equipment, while the media servers MSj may form MRF-P type equipment (for example like the equipment marketed by the Alcatel company as reference 8688 MRF 4.0).

We will now refer to FIG. 2 as a non-limitative example to describe the main steps necessary to setup and to control a media communication between a client terminal T and a media server MSj according to the invention.

In the following, it will be considered that the SIP protocol is used as the communication setup protocol. Implicit SIP messages that are unnecessary to understand the invention have been omitted from FIG. 2, to facilitate readability.

When a terminal T needs to access a particular service at the initiative of its user or the network core CR, it must initiate an SIP session with the application made to control and manage this service. To achieve this, the terminal T transmits a call set up message to the network core CR, in this case of the “SIP INVITE” type (arrow F1).

When the network core CR receives this message (SIP INVITE), it determines an application server AS1 dedicated to the service that it designates, and then routes the received message to this application server AS1 (arrow F2). When the application server AS1 receives the message (SIP INVITE), it may send a message, for example a “100 TRYING” type message, through the network core CR (arrow F3) and to the requesting terminal T (arrow F4), intended to notify it that it has received the message (SIP INVITE), so that it can disable some timeouts.

The application server AS1 then determines each capacity (or set of media functions) to assure each media part of the service denoted in the received message (SIP INVITE). It executes the service logic corresponding to the requested service, then generates a media control message to the resource management device D (active), for example of the INVITE type, comprising the identifier of the requesting terminal T and the identifier of the capacity (or the set identifier) that it has determined. This media control message (INVITE) is designed to create a media flow control session.

The network core CR routes the message (INVITE) to the active resource management device D (arrow F5). On reception of this message (INVITE), the management module MG of the device D determines the set identifier that it contains, and then accesses the database BD to determine the identifier of a media server MSj provided with resources to offer the required set (or capacity).

Then, once the management module MG has determined a media server MS3 adapted to the received message, it allocates resources (a channel) of this media server MS3, and transmits the received message through the network core CR to it, possibly after converting its communication setup protocol (arrow F6). It is important to note that this allocation may take account of any auxiliary data (availability state of resources and/or sizes of media servers MSj) and/or management information, for example such as priorities, as mentioned above.

When the media server MS3 receives the message (INVITE), it generates a response message to the application server AS1 through the network core CR, for example of the “200 OK” type, to signal that it has received its message correctly and that it will take it into account (arrow F7).

The media server MS3 then sets up a direct RTP type communication with the requesting terminal T designated in the message (INVITE) transmitted by the device D. This communication is obviously adapted to the requested service and therefore to the media flows that the media server MS3 and the requesting terminal T have to exchange by using media functions of the set designated in the message (INVITE) transmitted by the device D.

This media flow exchange takes place independently of the device D and the application server AS1, although under the control of the application server.

In the example shown in FIG. 2, the media control dialogue between the application server AS1 and the media server MS3 is of the session type. Consequently, the application server AS1 transmits a standard request message through the network core CR to the media server MS3, for example of the “INFO” type, containing a media command, for example requesting it to transmit a welcome message to the requesting terminal T (arrow F9). When it receives this message (INFO), the media server MS3 executes the command that it contains and transmits a response message to the application server AS1 through the network core CR, for example of the INFO type, to notify it that it has actually carried out its command (arrow F10).

A few moments later, the application server AS1 can transmit another standard request message to the media server MS3 through the network core CR, for example of the “INFO” type containing a media command, for example requesting it to send a credit card number to the requesting terminal T (arrow F11). On reception of this message (INFO), the media server MS3 executes the command contained in it and transmits a response message to the application server AS1 through the network core CR, for example an INFO type response message, to notify it that it has actually executed its command (arrow F12).

When the application server AS1 decides to terminate the dialogue with the media server MS3, it sends an end of session message to it, for example of the “BYE” type (arrow F13) through the network core CR. When this message (BYE) is received, the media server MS3 generates a response message to the application server AS1 through the network core CR, for example of the “200 OK” type, notifying it that it has actually received its last end of session message (arrow F14). This terminates the control of the communication by the application server AS1, and communication between the terminal T and the media server MS3, but this does not necessarily imply the end of the connection between the terminal T and the application server AS1 (the application server may decide to put the terminal T into relation with the equipment of another user, for example in the case of an application server dedicated to payment).

It is important to note that it would be possible to envisage a more complex implementation than that described with reference to FIG. 2. It is preferable that all messages exchanged by the application server AS1 and the media server MS3 should pass through the device D and that it should implement a “keep alive” type update mechanism, so that the device D can be informed of the end of a session and when the resources of a media server have been released.

The invention offers a number of advantages including:
a standard interface between application servers and media servers,
a multi-manufacturer environment,
sharing of a media server by several application servers developed by different manufacturers,
the provision of common media services defined by a common capacities base,
separation between the application layer (control plan) and the media layer (user plan),
global management of media server resources, possibly taking account in particular of all types of priorities and/or predefined (or multi-tenancy) multi-distribution situations,
a channel allocation (resources) of media servers that may be basic (for example of the “round-robin” type) or complex due to the fact that it takes account of parameters such as the geographic distribution of media servers or the quality of service (QoS),
application servers no longer need to store the list of media servers that they can reach, so that in the future it is possible to add or delete a media server from the network without needing to carry out any operation for application servers whatsoever. Conversely, media servers no longer need to know all application servers, such that there is no longer any reason to perform any operation at the media servers,
the cost of porting media parts of applications, initially designed for IN (Intelligent Network) type networks to NGM or IMS type networks is significantly reduced.

The invention is not limited to network management and equipment device embodiments described above solely as an example, but it encompasses all variants that those skilled in the art could envisage within the framework of the claims given below.

1. Device (D) dedicated to managing media server resources (MSj) in a communication network (CR), adapted to provide sets of media functions for providing the media parts of said requested services to client communication terminals (T) requesting services, comprising at least one media part, managed by application servers (ASi), characterized in that it comprises storage means (BD) storing data representative of media functions matching the media server identifiers (MSj), and management means (MG) adapted, upon receiving a message from an application server (ASi) dedicated to a service requested by a client terminal (T) and requiring the provision of a set of media functions to this client terminal for providing a media part of said requested service, to determine the identifier of a media server (MSj) having the resources for offering said requested set, in the storage means (BD), and then to allocate resources of said determined media server (MSj) so that the message may be transmitted thereto.

2. Device according to claim 1, characterized in that said storage means (BD) are arranged to store auxiliary data representative of availability states of resources of media servers (MSj) and/or the sizing of media servers (MSj) as a function of said data representative of sets of media functions and identifiers of media servers (MSj).

3. Device according to claim 1, characterized in that said management means (MG) are made to allocate resources of media servers (MSj) as a function of management information and/or said auxiliary data.

4. Device according to claim 3, characterized in that said management information is selected from a group including at least priority information, operating strategy information, geographic constraint information, geographic distribution of the media servers information, Quality of Service (QoS) information, network architecture information, and quality or state of the network information.

5. Device according to claim 1, characterized in that said storage means are arranged so as to be dynamically updated.

6. Device according to claim 3, characterized in that said storage means are arranged so as to be dynamically updated.

7. Device according to claim 5, characterized in that said management means (MG) are arranged to update said storage means (BD) when they receive information representative of sets offered by said media servers (MSj) and/or the corresponding available resources.

8. Device according to claim 7, characterized in that said data originate from said media servers (MSj).

9. Device according to claim 1, characterized in that it comprises i) an input interface (IE) adapted to receive messages conforming with a first protocol from said application servers (ASi), and transmit said messages to said management means (MG), and ii) an output interface (IS) adapted to transmit messages communicated by said management means (MG) and addressed to said media servers (MSj), to said media servers (MSj).

10. Device according to claim 5, characterized in that it comprises i) an input interface (IE) adapted to receive messages conforming with a first protocol from said application servers (ASi), and transmit said messages to said management means (MG), and ii) an output interface (IS) adapted to transmit messages communicated by said management means (MG) and addressed to said media servers (MSj), to said media servers (MSj).

11. Device according to claim 9, characterized in that said output interface (IS) is adapted to convert messages conforming with said first protocol into messages conforming with a second chosen protocol, before transmitting them to said media servers MSj to which they are addressed.

12. Device according to claims 9, characterized in that said first protocol is the SIP protocol.

13. Device according to claims 11, characterized in that said first protocol is the SIP protocol.

14. Device according to claim 9, characterized in that said first protocol is the SIP protocol encapsulating an AMSML type protocol.

15. Device according to claim 11, characterized in that said first protocol is the SIP protocol encapsulating an AMSML type protocol.

16. Device according to claims 11, characterized in that said second protocol is selected from a group including at least the SIP protocol encapsulating an XML type protocol and an H248 type protocol.

17. Device according to claim 1, characterized in that it is associated with a floating address.

18. Network equipment (SP), characterized in that it includes a management device (D) according to claim 1.
